(19) United States
(12) Patent Application Publication
(10) Pub. No.: US 2006/0106545 A1
(43) Pub. Date: May 18, 2006

(54) Methods of clustering proteins

(75) Inventors: Vitukudi N. Balaji, Bangalore (IN); Samiron Phukan, Bangalore (IN); Prasanna M. Dattatreya, Bangalore (IN); Ravi K. K. Raghunathan, Bangalore (IN)

Correspondence Address: MORRISON & FOERSTER LLP, 755 PAGE MILL RD, PALO ALTO, CA, 94304-1018, US

(73) Assignee: Jubilant Biosys Ltd., Bangalore (IN)

(21) Appl. No.: 11/208,378

(22) Filed: Aug. 19, 2005

(30) Foreign Application Priority Data
Nov. 12, 2004 (IN) 1191/CHE/2004

(51) Int. Cl. G06F 19/00

(52) U.S. Cl. 702/19; 702/20

(57) ABSTRACT

The invention relates to a method of clustering a set of proteins based on the sequence similarities of functional domain(s) such as pocket(s), functional site(s), allosteric site(s), and active site(s). The functional domain(s) of a protein sequence are identified based on the three-dimensional structure of the protein. Proteins are clustered based on the sequence similarity of the amino acid residues of the functional domain(s) and represented as a dendrogram. Proteins in a particular cluster show similar interaction patterns with specific drugs. Methods for identifying modulators for drug discovery based on the similarities of the functional domain(s) are provided.

### CROSS REFERENCE TO RELATED APPLICATIONS

This application claims priority to Indian Provisional Patent Aplication No. 1191/CHE/2004 filed Nov. 12, 2004, and Indian Patent Application Serial No. 1191/CHE/2004 filed May 18, 2005, the disclosures of each of which are incorporated by reference in their entirety.

### FIELD OF INVENTION

This invention relates to methods for profiling chemistry and structure of functional sites in proteins. Specifically, the invention relates to methods for clustering proteins based on sequence characteristics of functional site(s). The invention also relates to methods for identifying specific modulators of clustered protein targets for drug discovery.

### BACKGROUND OF THE INVENTION

During the past two decades, it has become clear that proteins can be differentially processed using alternative splicing mechanisms resulting in the production of several proteins from the same gene. As a result, the total number of distinct protein types expressed in various tissues of an organism over its life span far exceeds the number of genes. Thus, the proteome of a complex organism is likely to range up to hundreds of thousands or more different proteins, excluding allelic variants and the like.

This exploding quantity of gene and protein data makes it difficult to understand the role that a gene and its encoded proteins play in a cell, organism, or disease process. In order to translate such information into concrete benefits for humankind, it is necessary to develop methods that enable one to predict and to establish functions from the structure of proteins.

The most common and rapid computational methods for sequence analysis use conventional algorithms to perform sequence alignments of complete protein sequences. Alignment methods such as BLAST (Basic Local Alignment Search Tool, described in Altschul et al., J. Mol. Biol. 215, 403-410, (1990) and Karlin et al., PNAS USA 90:5873-5787 (1993)), WU-BLAST2 (Altschul, S. F. & Gish, W. (1996) Methods Enzymol. 266, 460-480), and FASTA (Pearson & Lipman, PNAS (USA), 85:2444, 1988) are typically employed for this purpose. Assignment of function is based on the theory that significant sequence identity allows one to infer functional similarity.

Newly discovered amino acid or nucleotide sequences frequently do not display any significant similarity with known sequences in the database. Indeed, many proteins or amino acid sequences (from 30-60% or more) that have been deduced from genome project-derived nucleotide sequence information represent novel protein families with unknown function. Furthermore, such conventional sequence alignment methods do not consistently detect functional and structural similarities, particularly when sequence identity is less than 25-30%.

The emerging viewpoint is that for sequences with less than 50% sequence identity, sequence similarity-based annotation transfer maybe unreliable. It is also known that even single amino acid changes can result in total abrogation of protein function. For these reasons, it is clear that alternatives to one-dimensional sequence alignment methods be made available which can accurately assess the biochemical function and allow clustering of the vast numbers of amino acid sequences that are being discovered through genomics.

In an attempt to overcome some of the problems associated while employing sequence alignments to predict protein function, several databases allowing homology searches across short, local sequence patterns or motifs have been designed. These databases, notably PROSITE (Hulo N., Sigrist C. J. A., Le Saux V., Langendijk-Genevaux P. S., Bordoli L., Gattiker A., De Castro E., Bucher P., Bairoch A. Recent improvements to the PROSITE database Nucl. Acids. Res. 32:D134-D137(2004)), BLOCKS (Henikoff S, Henikoff J G. Related Articles, Links Free in PMC Automated assembly of protein blocks for database searching. Nucleic Acids Res. 1991 Dec. 11; 19(23):6565-72.), PRINTS (Attwood, T. K., Bradley, P., Gaulton, A., Maudling, N., Mitchell, A. L. & Moulton, G. (2004) “The PRINTS protein fingerprint database: functional and evolutionary applications.” In Encyclopaedia of Genomics, Proteomics and Bioinformatics, M. Dunn, L. Jorde, P. Little & A. Subramaniam (Eds.).; Attwood T K, Bradley P, Flower D R, Gaulton A, Maudling N, Mitchell A L, Moulton G, Nordle A, Paine K, Taylor P, Uddin A, Zygouri C. PRINTS and its automatic supplement, prePRINTS. Nucleic Acids Res. 2003 Jan. 1;31(1):400-2. ), and PFAM (Alex Bateman, Lachlan Coin, Richard Durbin, Robert D. Finn, Volker Hollich, Sam Griffiths-Jones, Ajay Khanna, Mhairi Marshall, Simon Moxon, Erik L. L. Sonnhammer, David J. Studholme, Corin Yeats and Sean R. Eddy. The PFAM Protein Families Database. Nucleic Acids Research (2004) Database Issue 32:D138-D141), use local sequence information as opposed to global amino acid sequences for identifying sequence patterns that might be specific for a given function.

Alternatives to sequence-based methods include those based on protein structure. As stated above, it has been recognized for some time that biochemical property of a protein is a function of the three-dimensional arrangement of specific amino acid residues. Thus, two proteins having the same three-dimensional structure, perhaps not globally but in one or more discrete sub-structures or domains, may be expected to have similar biochemical properties. Small differences in the 3D configuration of the amino acid residues making up or influencing the functional site, as well as differences amongst the particular amino acid residues present, can alter such biochemical properties as ligand specificity, binding affinity, pH tolerance and catalytic rate.

Several general approaches have been developed to analyze protein structure. In addition to experimental methods such as X-ray crystallography and NMR spectroscopy, various computational methods have also been developed to generate three-dimensional structural models for proteins, including exact models. These techniques include threading, comparative modeling and ab initio processes. A major advantage in computationally generating three-dimensional protein models is the efficiency in terms of speed. One can generate thousands of structural models in a day using these computational methods.

Until now, sequences were compared directly by homology or similarity alignment for sequence analysis, clustering and tree constructions. Several limitations are encountered while using these comparison methods. These methods involve complex mathematical functions and are usable only under precisely defined conditions. They are also numerically unstable and limited by their resolution. Moreover, an alignment of a complete genome sequences with any length is also not possible. Further, methods known in the art are dependent on the sequence origin and coordinated on this origin during analysis. Another disadvantage of the methods known in the art is that the sequences are compared directly by their homology or similarity, totally disregarding the functionality aspect which resides in the three-dimensional conformation.

There are several clustering methods which are available for classifying protein sequences. U.S. Pat. Application No. 2003/0096307 discloses an approach which is directed to a classification method based on functional site profiles of proteins. The invention further discloses the methods of obtaining an amino acid sequence for one or more proteins of interest and analyzing the sequences with one or more functional site profiles to determine if the functional site profiles exists in the amino acid sequence of the protein of interest. If so, the protein of interest is classified as having the biochemical function corresponding to the functional site profile. These functional site profile-based classifications can be used for drug discovery process.

One current approach is related to a method of classification and tree construction using whole or partial sequences such as gene sequences, protein sequences through correlation analysis is disclosed in W02004/057511.

U.S. Patent Application No. 2004/0148105 is directed to a method of identifying the ionizable residues in the protein with anomalous predicted titration behavior and searches for the clustering of those residues into putative interaction sites. This method utilizes a computational method known as Theoretical Microscopic Titration Curves (THEMATICS; Ondrechen M J, Clifton J G, Ringe D. THEMATICS: a simple computational predictor of enzyme function from structure, Proc Natl Acad Sci USA. 2001 Oct. 23; 98(22):12473-12478.) which is used to determine the functional activity at the atomic and molecular level of a given protein.

U.S. Pat. No.6,304,868 discloses a method of grouping sequences in families. The method is based on the finding that rapid grouping can be achieved when traditional database searching programs are run iteratively to find a quantity of sequences related to a given protein sequence.

All the clustering methods listed above cluster the proteins as related or divergent based on the whole sequence similarity. Often times the functionally similar sequences maybe grouped in unrelated clusters in the dendrogram or the classification tree. This is a major concern when the inferences made from such clustering methods are employed for drug discovery.

### SUMMARY OF THE INVENTION

The present invention relates to a method of clustering a set of proteins based on the sequence similarities of functional domains such as pocket(s) and functional site(s). It involves converting a reference DNA sequence to predicted peptide sequence followed by checking whether it is belongs to any protein class. It further involves deriving a three dimensional structure of the proteins experimentally or computationally. It further involves identification and characterization of pocket(s) or functional site(s) using the pocket information followed by deduction of the sequence information from the active sites identified from the three-dimensional structure of the protein. The proteins of interest are subsequently clustered based on the sequence similarity of the pocket(s) or functional site(s) and a cluster tree is constructed. The proteins in a particular cluster show similar interactions with specific drugs. These interaction patterns can be useful in identifying potential drug targets. The invention further provides a method for identifying broad and specific target modulators for drug discovery.

Current methods for drug discovery are experimental and require empirical assays for all the related proteins with the drug in question to determine the interaction pattern of the drug. This is a time consuming and expensive method for drug discovery.

Computational methods also contribute in drug discovery. These methods, known as in silico drug discovery methods, are cost effective, faster and describe an efficient way for designing new drugs for disease treatment.

A need nevertheless exists for an efficient method aimed at determining the interaction of a drug with the disease protein and its related family. The present invention provides a method for identifying broad and specific target modulators for drug discovery.

An object of the present invention relates to a method of clustering a set of proteins based on the sequence similarities of pocket(s) or functional site(s).

Yet another object of the present invention involves identifying the pocket(s) or functional site(s) of a set of proteins from its three-dimensional structure.

Yet another object of the present invention involves characterizing the pocket(s) or functional site(s)

Yet another object of the present invention involves deducing the sequence of the pocket(s) or functional site(s)

Yet another object of the present invention involves clustering said set of proteins based on the sequence similarity of the pocket(s) or functional site(s)

Yet another object of the present invention involves generating a dendrogram for said clustered set of proteins comprising protein clusters having similar binding properties.

Yet another object of the present invention relates to a clustering method for proteins based on their functional site similarities.

Yet another object of the present invention provides a drug discovery method for identifying a drug to treat a particular disease condition based on the drug interaction with the proteins which are clustered on the basis of functional similarities.

Yet another object of the present invention provides cost effective method of developing assays to study the interaction of a particular drug with the disease proteins.

Yet another object of the method provides assays for similar proteins to study the interaction pattern of the drug rather than having assays for all proteins.

Yet another object of the present invention provides faster means for testing the interaction pattern of the drug with the protein utilizing the clustering tree of the present invention.

### BRIEF DESCRIPTION OF THE DRAWINGS

The current invention is illustrated by way of example, and not by way of limitation, in the accompanying drawings, where like reference numerals refer to similar elements and in which:

FIG. 1 illustrates the three-dimensional structure of GSK3β and the ligand binding sites.

FIG. 2 depicts the amino acid residues at the active sites and the structure of GSK3β protein sequence.

FIG. 3 is a schematic representation of the method for identification the functional sites of a protein sequence.

FIG. 4 depicts the process flow diagram for the method of clustering proteins.

FIG. 5 illustrates the Human Kinome as disclosed by Manning et al. (Manning G, Whyte D B, Martinez R, Hunter T, Sudarsanam S. The protein kinase complement of the human genome. Science. 2002 Dec. 6; 298(5600):1912-1934.)

FIG. 6 dendrogram showing the classification based on the present invention using the sequence similarity of the pocket residues.

FIG. 7 flow diagram showing the method of identifying a drug for the disease treatment.

### DESCRIPTION OF THE INVENTION

The present invention is directed to a classification method based on functional site profiles of proteins as against the conventional methods that utilize the information in the primary structure of the proteins in order to draw similarities and cluster proteins as related or unrelated. The invention further discloses the methods of obtaining amino acid sequence for one or more proteins of interest and scanning the sequence for the presence of one or more functional site profiles in the protein of interest by scanning the LIGPLOT (Wallace A. C., Laskowski, R. A. and Thornton, J. M. (1995) LIGPLOT: A program to generate schematic diagrams of protein-ligand interactions. Protein Eng., 8, 127-134) database of PDBSUM (Roman A. Laskowski, PDBsum: summaries and analyses of PDB structures, Nucleic Acids Res. 2001 Jan. 1; 29(1): 221-222; accessible via the web at www.ebi.ac.uk/thornton-srv/databases/pdbsum/). If the signature amino acid residues encoding functional sites are detected, the protein of interest is classified as having the biochemical function corresponding to the functional site profile. These functional site profile-based classifications can be used for drug discovery process.

Definitions

Certain terms used in the context of describing the invention are defined before describing the invention in general and in terms of specific embodiments. In addition to their art recognized meanings, the following terms have the following meanings when used herein. The terminologies that are not defined below or elsewhere in the specification have their art-recognized meaning.

An “agonist” is a compound that binds to modulate the biochemical activity of a functional site of a protein. An agonist can be a “negative agonist” or “antagonist” i.e., a compound that decreases the activity of a protein, or a “positive agonist”, i.e., a compound that increases the activity of a protein. Agonists and antagonists include, but are not limited to, small molecules, proteins, lipids, and carbohydrates.

An “inhibitor” is a molecule that, when it binds to a target, can decrease physiological activity of the target (e.g., render the target less functional) or block its activity (e.g., render the target non-functional). In some embodiments, an inhibitor can be a small molecule of less than 1000 daltons, a small molecule of less than 750, 600 or 500 daltons, a polypeptide of naturally occurring or not naturally occurring amino acids, a peptide of naturally occurring or not naturally occurring amino acids, a peptoid, a peptidomimetic, a synthetic compound, a synthetic organic compound, or the like. For example, a target (e.g., an enzyme, such as a kinase) which is rendered “less functional” by an inhibitor refers to a target (e.g., an enzyme, e.g., a kinase) having detectable activity which is less than its activity under physiological conditions. A target (e.g., an enzyme, e.g., a kinase) is rendered “non-functional” by an inhibitor if its activity is not detectable by a standard biological assay (e.g., an enzyme inhibition assay, e.g., a kinase inhibition assay).

The term “motif” refers to a group of amino acids in the protein that defines a structural compartment or carries out a function in the protein, for example, catalysis, structural stabilization or phosphorylation. The motif may be conserved in sequence, structure and function when. The motif can be contiguous in primary sequence or three-dimensional space.

As will be appreciated, many embodiments of the invention are implemented in silico. In such embodiments, actual physically existing amino acids, peptide fragments, are not employed; instead, electronic or other machine manipulable data forms representing these molecules are used.

A “pocket” of a protein refers to specific binding sites of proteins which are located at indentations or cavities in the protein surface allowing the protein to contact and recognize a significant fraction of the substrate surface. Pocket can be of any site present in a protein such as functional site, allosteric site, non-allosteric site, protein-protein interaction sites, and ligand binding sites.

A “functional site” of a protein refers to any site in a protein that has a function. Representative examples include active sites (i.e., those sites in catalytic proteins where catalysis occurs), protein-protein interaction sites, sites for chemical modification (e.g., glycosylation and phosphorylation sites), and ligand binding sites. Ligand binding sites include metal ion binding sites, co-factor binding sites, antigen binding sites, substrate channels and tunnels, and substrate binding sites.

An “allosteric site” on a protein is a site that is spatially distinct from the substrate binding site of the target that when occupied by a ligand (e.g., an allosteric ligand) modulates (inhibits or enhances) or prevents binding of the substrate and thereby, a function of the protein. For example, an “allosteric site” on a kinase is a site that is spatially distinct from the ATP binding site of the target (e.g., the kinase) that when occupied by a ligand (e.g., allosteric ligand) modulates (e.g., inhibits) or prevents ATP binding and, thus, kinase function. A spatially distinct “allosteric site” on a target (e.g., a kinase) can also modulate or prevent substrate binding with similar effects on target (e.g., kinase) function. “Spatially distinct from the substrate binding site” refers to a binding site that is separate from the substrate binding site and is defined by amino acid residues within the protein that taken together are not identical to the sequence of amino acids that define the substrate binding site. A site that is spatially distinct from the substrate binding site can differ from the substrate binding site in length of amino acids, can differ by a single amino acid, or can differ in the order of amino acids in the sequence comprising the site. The allosteric site is thus spatially distinct or distinguishable from the substrate binding site (e.g., the substrate binding site and the allosteric binding site are not one in the same). It is possible that the allosteric site of the invention partially overlaps the substrate binding site but the allosteric site and the substrate binding site are not to be construed as one and the same. The methods described herein can be applied to identifying ligands (e.g., inhibitors) that bind to a protein (e.g., a kinase) at an allosteric site and by binding the allosteric site, these ligands (e.g., inhibitors) lock, confine, or hold the substrate binding site in a position that physically prevents the substrate from binding to the protein thus allowing for inhibition of the protein in this novel manner.

The term “ligand” refers to a molecule that associates or binds with a receptor (e.g., interacts in a covalent or non-covalent manner). In some cases, the binding of the ligand to the receptor can have a biological effect (e.g., agonism or antagonism). For example, the ligand can be a polypeptide (e.g., a protein) binding to a biomolecule (e.g. DNA molecule) wherein the binding of the protein to the DNA has initiates mRNA synthesis. The ligand can also be an organic molecule (e.g., a pharmaceutical compound, a small molecule) bound to an enzyme (e.g., HIV protease) wherein the binding of the organic molecule to the enzyme modulates (inhibits or enhances) or prevents enzymatic activity.

As used herein, the “biochemical function” of a functional site refers to the biological and/or chemical and/or physiological function related to the site in a biologically active protein that possesses the corresponding function. The protein may be naturally or non-naturally occuring. In some embodiments, the biochemical function of an active site refers to the specific catalytic activity of the site, whereas the biochemical function of a substrate binding site refers to the binding of t particular substrate to the site.

In one aspect of the invention, a “cluster” refers to a cluster of proteins that exhibit the same function, e.g., two proteins that exhibit protein tyrosine kinase activity are members of the same cluster, or otherwise possess a common functional attribute that allows for classification.

The term “modulate” refers to a change in the biochemical activity corresponding to the functional site profile. For example, modulation may involve an increase or a decrease in catalytic rate and substrate binding characteristics. Modulation may occur by covalent or non-covalent interaction with the protein, and can involve an increase or decrease in biochemical activity.

The term “derivative” refers to a chemical modification of a protein. A derivative protein, e.g., one modified by glycosylation, pegylation, or any similar process, retains the biochemical activity corresponding to the functional site profile.

The term “fragment” of a protein refers to a polypeptide comprising fewer than all of the amino acid residues of the naturally occurring or otherwise pre-existing or known protein but retains the biochemical activity corresponding to the functional site profile. As will be appreciated, a “fragment” of a protein may be a form of the protein truncated at the amino terminus, the carboxy terminus, and/or internally (such as by natural splicing), and may also be variant and/or derivative.

A “domain” of a protein is also a fragment, and comprises the amino acid residues of the naturally occurring or otherwise pre-existing or known protein required to confer the biochemical activity corresponding to the functional site profile.

A “functional domain” of a protein, according to this invention, is composed of parts of the amino acid sequence of the protein comprising the amino acid residues required to confer a property related to a function of the property of the protein. A functional domain thus includes the amino acid residues that comprise a substrate binding site, an active site, a ligand binding site, an allosteric site, a pocket, a functional site and a protein-protein interaction site and the like. Amino acid residues comprising a functional domain can form a structure related to an identifiable property of the protein. Amino acid residues comprising a functional domain can also form a structure containing specific amino acid residues related to an identifiable biochemical function of the protein. The biochemical functions include inhibition, activation, enhancement, modulation, binding, and allosteric effects.

In addition to primary structure, proteins also have secondary, tertiary, and quaternary structure. “Secondary structure” refers to local conformation of the protein chain, with reference to the covalently linked atoms of the peptide bonds and α-carbon linkages that string the amino acid residues of the protein together. Representative examples of secondary structures include α helices, parallel and anti-parallel β structures, and structural motifs such as helix-turn-helix, β-α-β, the leucine zipper, the zinc finger, the β-barrel, and the immunoglobulin fold. “Tertiary structure” concerns the three-dimensional structure of a protein, including the spatial relationships of amino acid side chains and atoms, and the geometric relationships of different regions of the protein. “Quaternary structure” refers to the structure and non-covalent association of different polypeptide subunits in a multi-subunit protein.

The terms “specific binding”, “specifically binding”, “specificity”, and the like refer to an interaction between a protein and a modulator (e.g., an agonist or an antagonist) that is not random. “Selective binding”, “selectivity”, and the like refer to the preference of a compound to interact with one molecule as compared to another. Preferably, interactions between compounds, particularly modulators, and proteins are both specific and selective.

A “target protein” refers to a protein used in a discovery process. In general, target proteins are used in screening assays to identify compounds that modulate the activity of the protein.

Clustering Proteins Based on Sequence Similarities of Functional Domains

Algorithms used to cluster protein sequences can be either domain-based or family-based. Clustering methods involve an all-against-all pairwise protein sequence similarity searches. The domain-based clustering methods organize the protein sequence universe into domain clusters where domains are the structural units of proteins. Family-based clustering methods group protein sequences into families, which contain a group of evolutionarily related proteins that share similar domain architecture.

It is understood by one skilled in the art that the structurally homologous protein families are likely to exhibit similar biochemical functions due to a conservation of active site chemistry and geometry. Although such functional sites are well conserved within families, a subset of key amino acid residues typically varies among the constituted proteins. This differentiation results in their distinct biochemical activities (e.g., catalytic rate and substrate specificity). These detailed differences among family members allow precise recognition processes, and knowledge thus gained may be exploited in computational methodologies aimed at discovery of structural moieties involved in highly specific functions, as well as for other uses, such as in protein family, sub-family classification, protein engineering and discovery of compounds that react specifically with a particular member (e.g., a target protein), or subset of members of a protein family.

Biochemical function of a protein is characterized by its interaction with the other bio-molecules in a specific pathway. The structural conformation of a protein determines its functionality. If a protein's structure is changed (mutated), it leads to a conformational change in its structure and hence leads to an abnormal behavior which we call as diseases condition. The protein with a particular defect is known as disease protein.

The invention relates to a method of clustering a set of proteins based on the sequence similarities of the pocket(s) or functional site(s). It pertains to clustering on the basis of the similarities of the pocket(s) or functional site(s) residues, leading to similar interacting residues with a ligand molecule. In the process, once a ligand and the corresponding active sites residues are known, it is presumed that a particular ligand may affect other proteins with similar residues in the active sites. In this way one can predict the side effect of an inhibitor molecule. Analysis of biochemical pathways would determine the similar proteins with the similar kind of interaction with an inhibitor.

An embodiment of the present invention relates to a method of clustering a set of proteins based on functional domain(s) including but not limited to pocket(s) or functional sites(s), comprising the steps of: (a) providing a query sequence by converting a reference DNA sequence to a predicted polypeptide sequence; (b) searching at least one database wherein the query sequence is compared to at least one sequence in the database; (c) retrieving one or more similar or related protein sequences based on comparison with the query sequence; (d) obtaining a three-dimensional structure of said protein(s); (e) identifying a functional domain(s) of said proteins from said three-dimensional structure; and (f) clustering said protein sequences based on a sequence similarity of the functional domain(s). In some embodiments a dendrogram is generated to visualize the protein cluster data.

In a preferred embodiment, the present invention relates to method that converts a reference DNA sequence to a predicted peptide sequence using GENSCAN, GRAIL, HMMgene, MZEF, Genfinder, Genemark, GeneEXP, or Gen Lang. The method of converting a reference DNA sequence to a predicted peptide sequence using GENSCAN is provided in EXAMPLE 1. The reference DNA gene sequence is screened whether it belongs to any protein class using BLASTP (NCBI database), PFAM (Protein families database of alignments and HMMs) or PROSITE (Expasy). If it belongs to a particular class of proteins, the sequence is taken for further analysis to identify the pocket(s) or functional site(s). Otherwise, it is suggested to develop new method of identifying the pocket(s) or functional site(s) using threading techniques and tool such as like Threader (Jones, D. T., Taylor, W. R. & Thornton, J. M. (1992) A new approach to protein fold recognition. Nature. 358, 86-89.).

Yet another preferred embodiment relates to deriving a three dimensional structure of the proteins experimentally or from methods like X-ray crystallography or nuclear magnetic resonance (NMR). Although experimental structure determination methods provide high-resolution 3D structure information about a subset of the proteins, several computational prediction methods are available in public domain that curate the information from experimentally determined structures for a large number of proteins in a database and allow for prediction of the structure for unknown proteins whose structure is not determined experimentally. This is based on the information derived from experimentally determined structures. Some of these computational prediction methods use information from PDB (Protein Data Bank) to generate a 3D structure of an unknown protein. The three-dimensional protein model that is generated can be high, medium or low resolution. The softwares used for computationally determinig three dimensional structures can be Modellar (Sali A. and T. L. Blundell. Comparative protein modelling by satisfaction of spatial restraints. J. Mol. Biol. 234, 779-815, 1993.), Prime (Andrec, M.; Harano, Y.; Jacobson, M. P.; Friesner, R. A; Levy, R. M., “Complete protein structure determination using backbone residual dipolar couplings and sidechain rotamer predication”, J. of Structural and Functional Genomics, 2002, 2, 103-111.), Swissmodel (Guex N and Peitsch M C (1997) SWISS-MODEL and the Swiss-PDB Viewer: An environment for comparative protein modelling. Electrophoresis 18:2714-2723.), or CPH model (O. Lund, M. Nielsen, C. Lundegaard, P. Worning CPH models 2.0: X3M a Computer Program to extract 3D Models. Abstract at the CASP5 conference A102, 2002.).

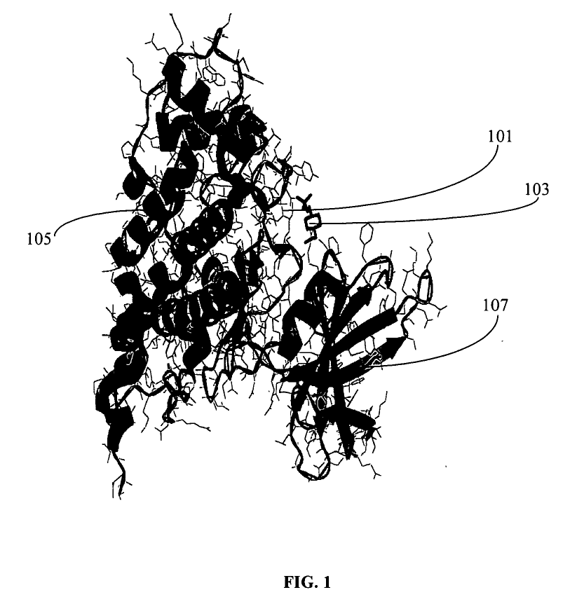

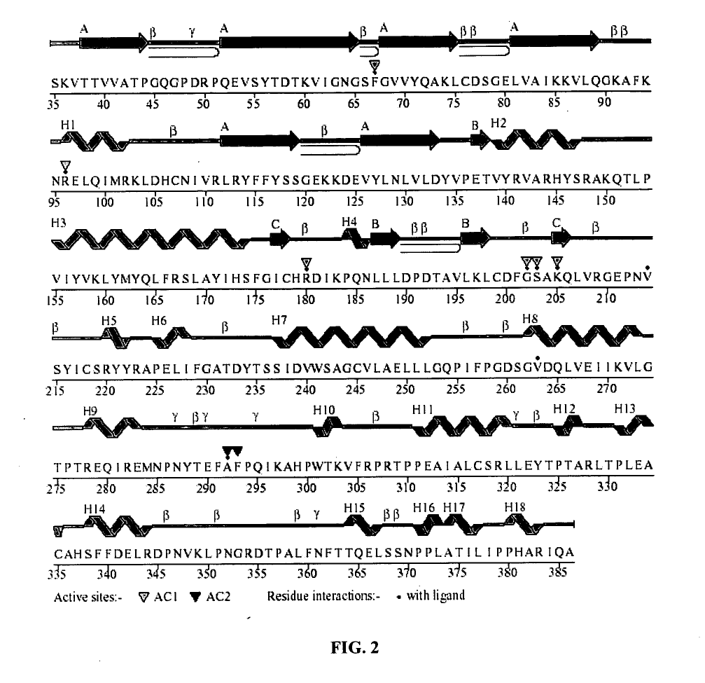

EXAMPLE 2 provides the identification of pocket(s) or functional site(s) using the pocket information. FIG. 1 illustrates the three-dimensional structure of GSK3Beta (PDB id 1h8f) downloaded from the PDBSUM (Laskowski R A (2001). PDBsum: summaries and analyses of PDB structures. Nucleic Acids Res., 29, 221-222). The sequence of the protein having PDB id 1h8f in the PDBSUM exhibits two active site pockets (AC1, AC2) as shown in the FIG. 2. The ligand binding site 101 and the ligand 103 are further illustrated in FIG. 1. The structure further shows the alpha helix 105 and β sheets 107 of the protein.

Yet another embodiment involves identification of pockets using the pocket information beyond just sequence consisting of sequence of exposed residues, and sequences of different layers from the pockets. The exposed residues are the residues in the active site which can directly interact with the modulator. The buried layer of the active site residues are those which are not in contact which are modulator but contributes to the structure of the active site pocket. The modulator binds in the active site of the protein to modulate its activity. The three dimensional conformation of the active site in the protein has two types of residues such as buried and exposed ones. The exposed residues directly interact with the modulator which results in the alteration in the activity profile of the protein. The buried residues which do not interact directly with the modulator are also responsible for the structural conformity of the active site. The residues exposed in the active site and their properties are the prime consideration in designing modulators which can be a potential drug.

These computational methods also reveal a three dimensional surface representation of the active sites (for the details, see EXAMPLE 2). Other outputs include information on the orientation of the amino acid residues as buried or exposed in a protein.

The modulator binds in the active site of the protein to modulate its activity. The three dimensional conformation of the active site in the protein has two types of residues such as buried and exposed ones. The exposed residues directly interact with the modulator which results in the alteration in the activity profile of the protein. The buried residues which do not interact directly with the modulator are also responsible for the structural conformity of the active site. The residues exposed in the active site and their properties are the prime consideration in designing modulators which can be a potential drug.

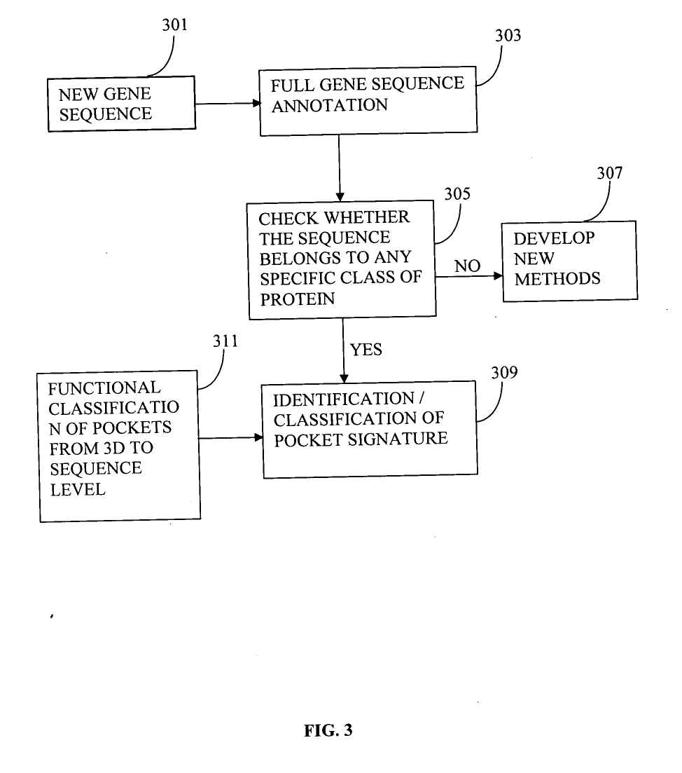

EXAMPLE 3 provides the method of obtaining final structure conformation of the protein with respect to the sequence. FIG. 2 is the pictorial representation of the active site residues and the structure of GSK3Beta protein sequence (PDB id 1H8F) which denotes the alpha helix (H1-H18), the beta sheets (A), loops (β), and residues in the active site pockets (AC1, AC2). It is the summary of the protein structure with respect to its sequence (GSK3Beta; PROSITE number PS00108). FIG. 3 illustrates the summary of methodology of predicting the functional sites of a protein sequence. The method involves the identification of function site for a protein. The method converts a reference DNA sequence 301 to a predicted peptide sequence 303. The reference DNA sequence is checked 305 whether it is belongs to any protein class. If it belongs to a particular class of proteins, the sequence is taken for further analysis to identify the pocket(s) or functional site(s). Otherwise, it is suggested to develop new method 307 of identifying the pockets. The pockets are identified 309 using the pocket information beyond just sequence consisting of sequence and exposed, sequence, exposed, and layers, and sequence in pocket and sequence in inner layer. The method involves the functional classification of pockets from three dimensional to sequence level 311.

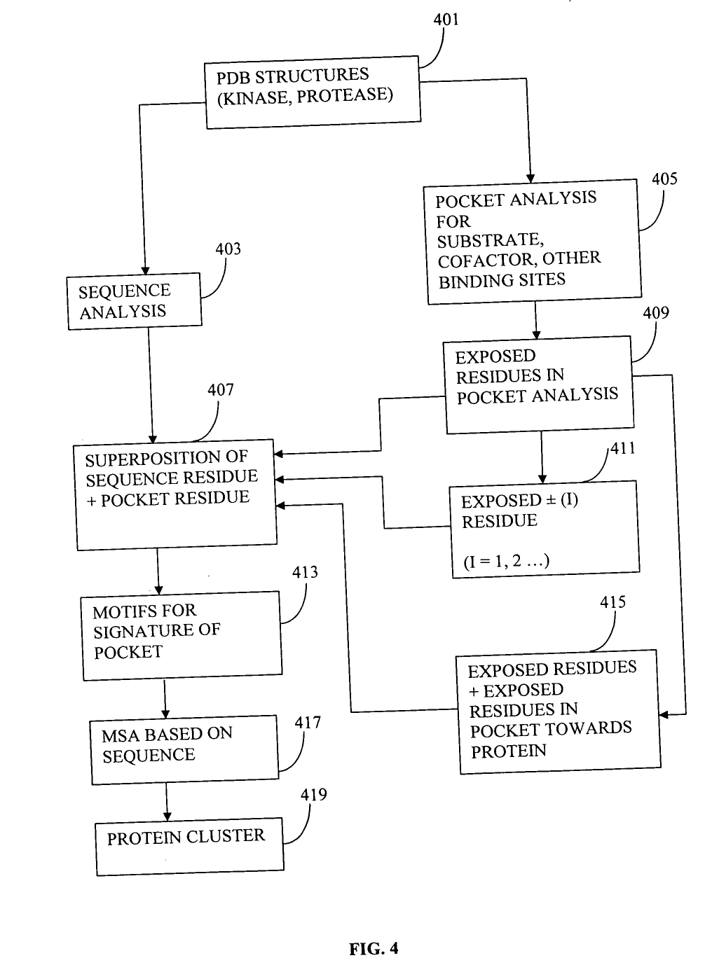

Yet another embodiment involves characterizing the identified pocket(s) or functional site(s) for presence of substrate, cofactor, and other binding sites. The exposed residues, exposed residue±(I) residue (where I=1, 2, . . . ), and exposed residues+exposed residues in pocket(s) or functional site(s) towards protein are taken for superposition along with sequence residue. EXAMPLE 4 explains the characterization of the identified pocket(s) or functional site(s) for presence of substrate, cofactor, and other binding sites. FIG. 4 illustrates the process flow diagram for the method of clustering proteins. The three dimensional protein structures are obtained from the PDB 401 for further analysis. The pocket(s) or functional site(s) of the protein are analyzed 403 for substrate, cofactor, and other binding sites 405. The exposed residues 409, exposed residue±(I) residue 411 (where I=1, 2, . . . ), and exposed residues+exposed residues in pocket(s) or functional site(s) towards protein 415 are taken for superposition along with sequence residue 407. The motifs for signature of pocket(s) or functional site(s) are derived 413. Then the multiple sequence alignment 417 is done and the protein clusters 419 are derived through classification or clustering using the multiple sequence alignment results. The pocket(s) or functional site(s) residues of proteins are used as input sequences in the software CLUSTALW (J. D. Thompson et al. Clustal W : Improving the sensitivity of progressive multiple sequence alignment through sequence weighting, position-specific gap penalties and weight matrix choice. Nucleic Acids Res., 22:4673-4680 (1994)) and the multiple sequence alignment is done. CLUSTALW is a general purpose multiple sequence alignment program for DNA or proteins. It produces biologically meaningful multiple sequence alignments of divergent sequences. It calculates the best match for the selected sequences, and lines them up so that the identities, similarities and differences can be seen. Evolutionary relationships can be analyzed based on the cladograms or phylograms. The alignment file is derived from the multiple sequence alignment. The output file is available in .dnd file. Clustering of the proteins of the instant invention is done with the help of the software called PHYLODRAW which supports the .dnd format of the output file from CLUSTALW. This program can export the final tree layout to BMP (bitmap image format) and Postscript. The clustering tree is obtained from the .dnd file.

Yet another embodiment for the current invention relates to functional classification of pocket(s) or functional site(s) from three dimensional to sequence level. It involves manually deducing the sequence information from the identified active sites identified from the predicted 3-D tertiary structure. The amino-acid pocket residues derived from functional sites of the protein are used as input sequences and subjected to a multiple sequence alignment using such software as CLUSTALX (Thompson et al., 1997) or CLUSTALW, using the default parameters. CLUSTALW is a general purpose multiple sequence alignment program for DNA or proteins. It produces biologically meaningful multiple sequence alignments of divergent sequences. It calculates the best match for the selected sequences, and lines them up so that the identities, similarities and differences can be seen. The alignment file .aln is derived from the multiple sequence alignment (MSA).

The mutations in the active site residues are identified through pair-wise comparison and evolutionary relationship are thus drawn which is the basis of the clustering. The output file is available as dnd file. The clustering of the proteins can be visualized as phylogram or cladograms using software such as PHYLODRAW (Jeong-Hyeon Choi, Ho-Youl Jung, Hey-Sun Kim, Hwan-Gue Cho. PhyloDraw: a phylogenetic tree drawing system, BIOINFORMATICS, 16(11), pp 1056-1058, November 2000) or TREEVIEW (R. D. M. Page. Treeview: An application to display phylogenetic trees on personal computers. Computer Applications in the Biological Sciences, 12:357-358 (1996)) which support the dnd format of the output file from CLUSTALW.

There are several tools for drawing phylogenetic trees such as NJPLOT, GENETREE, PHYLIP, GENEDOC, DAMBE, TREECON, TREEVIEW AND SPECTRUM (G.Perriere and M.Gouy. WWW-Query : an online retrieval system for biological sequence banks. Biochimie, 78:364-369; J.Felsenstein. Phylip: Phylogeny inference package. version 3.5. University of Washington, Seattle, Wash., 1993.; R. D. M. Page. Treeview: An application to display phylogenetic trees on personal computers. Computer Applications in the Biological Sciences, 12:357-358, 1996; R. D. M.Page and M. A. Charleston. From gene to organismal phylogeny : Reconciled trees and the gene tree/species tree problem. Molecular Phylogenetics and Evolution, 7:231-240, 1997). PHYLODRAW is a unified viewing tool for phylogenetic trees. PHYLODRAW supports various kinds of multialignment programs (such as DIALIGN (B. Morgenstern et al. DIALIGN: Finding local similarities by multiple sequence alignment. BIOINFORMATICS, 14(3):290), CLUSTALW, PHYLIP format, NEXUS MEGA and pairwise distance matrix) and visualizes various kinds of tree diagrams, such as rectangular cladogram, slanted cladogram, phylogram, free tree, unrooted tree and radial tree. A pairwise distance matrix is a matrix of the evolutionary distance between every pair of species. With PHYLODRAW users can manipulate the shape of a phylogenetic tree easily and interactively by using several control parameters. This program can export the final tree layout to BMP (bitmap image format) and Postscript. The functional classification of functional domains from three dimensional to sequence level is explained in EXAMPLE 5.

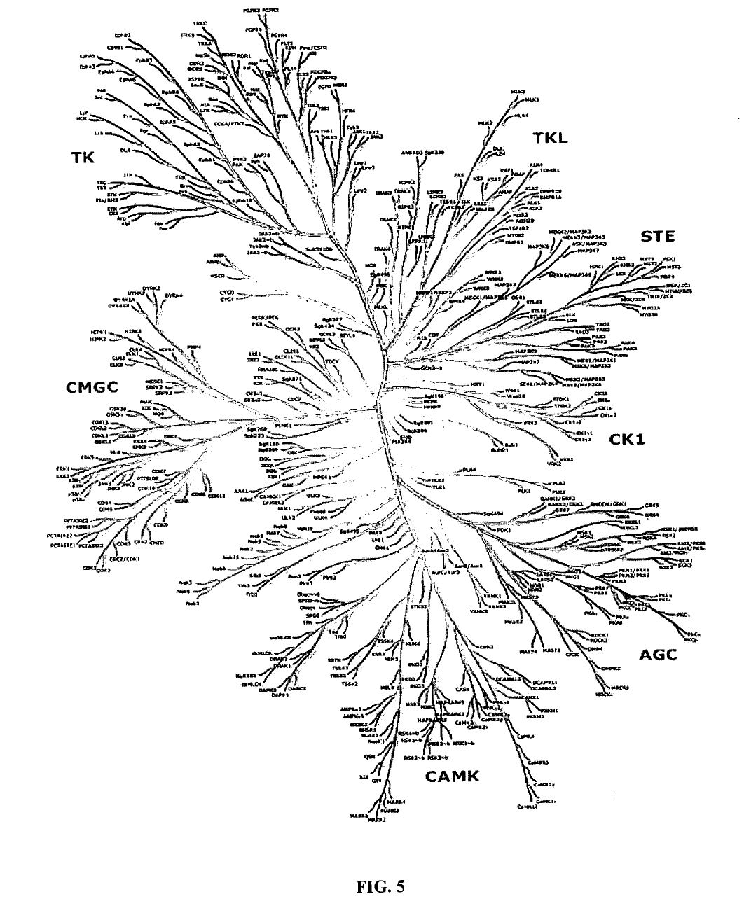

Yet another embodiment of the present invention relates to comparing the clustering tree representing Human Kinome disclosed generated by earlier methods according to Manning et al., 2002 with the one generated by our novel method. FIG. 5 illustrates the Human Kinome disclosed in Manning et al., 2002. This clustering tree provides clusters of human kinase enzymes. The clustering is based on the whole sequence similarity of the domains of these enzymes which classifies the human kinases into a hierarchy of groups, families, and subfamilies. Kinases were classified primarily by sequence comparison of their catalytic domains of the global sequence aided by knowledge of sequence similarity and domain structure outside of the catalytic domains. The knowledge of the exact chromosomal locations of genes afforded by the complete human genome assemblies is increasingly valuable in pinpointing candidate disease genes within loci that are associated with specific diseases. Comparison of the kinase chromosomal map with known disease loci indicates that 164 kinases map to amplicons seen frequently in tumors and 80 kinases map to loci implicated in other major diseases. The role of kinases as biological control points and their tractability as drug targets make them attractive targets for disease therapy.

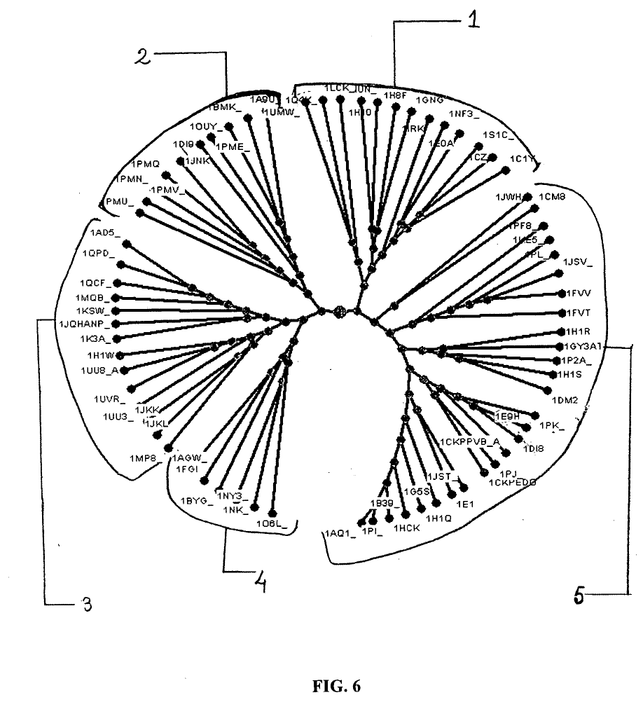

FIG. 6 is a dendrogram showing the classification based on the present invention using the sequence similarity of the pocket residues. This clustering tree is based on 68 human kinases. The clustering tree provides the PDB ids for the corresponding kinases. The kinase names for the appropriate PDB ids are depicted in TABLE 1. The corresponding kinase names can be made available using the PDB ids of TABLE 1. The clustering tree surprisingly provides a clustering tree comprising clusters of functionally related proteins. The clustering tree of the present invention comprises of five different sub clusters.

TABLE 1

| PDB ids | Kinase type | PDB ids | Kinase type |
|---|---|---|---|
| 1gng | Gsk3Beta | 1k3a | Irs1 |
| 1h8f | Gsk3Beta | 1mp8 | Fak |
| 1h10 | Atk1 | 1fgi | Fgfr |
| 1nun | Fgf10 | 1agw | Fgf Receptor 1 |
| 1h1w | Hpdk | 1byg | Csk |
| 1uu8 | hpdk1 | 1ny3 | Map |
| 1uvr | Hpdk1 | 1o61 | Akt2 |
| 1q4k | Plk | 1jnk | jnk3 |
| 1umw | Plk | 1hck | Cdk2 |
| 1lck | lck | 1b39 | Cdk2 |
| 1c1y | Raf1 | 1pxi | p33 |
| 1s1c | H12 | 1h1q | Cdk2 |
| 1e0a | Cdc42 | 1g5s | Cdk2 |
| 1cxz | Pkn | 1e1x | Cdk2 |
| 1nf3 | Cdc42 | 1aq1 | Cdk |
| 1irk | Ir | 1jst | cAMP dependent |
| 1uu3 | hpdk1 | 1ckp | Cdk1 |
| 1a9u | Map | 1di8 | Cdk2 |
| 1bmk | Map | 1pw2 | Cdk2 |
| 1ouy | Map | 1e9h | Cdk2 |
| 1pme | Erk2 | 1pxk | Cdk2 |
| 1di9 | Map | 1dm2 | Cdk2 |
| 1jnk | jnk3 | 1h1s | Cdk2 |
| 1pmq | jnk3 | 1p2a | Cdk2 |
| 1pmu | Jnk3 | 1gy3 | Pcdk2 |
| 1fvr | Tie-2 | 1h1r | Cdk2 |
| 1ad5 | Src | 1fvt | Cdk2 |
| 1qcf | Hck | 1jsv | Cdk2 |
| 1qpd | Lck | 1fvv | Cdk2 |
| 1mqb | Epha2 | 1ke5 | Cdk2 |
| 1jqh | Igf | 1pxl | Cdk2 |
| 1ksw | C-src | 1cm8 | Map |
| 1jkk | Dap | 1pf8 | Cdk2 |
| 1jkl | Dap | 1jwh | Ck2 |

Yet another embodiment of present invention involves utilizing the information from the protein clusters of the instant invention to identify potential drug for the treatment of a disease. In the present invention, inhibitory effect of commercially available kinase inhibitors namely, Kenpaullone, Alsterpaullone, Purvalanol, Roscovitine, Pyrazolopyrimidine (PP1), PP2, and ML-7 (Bain, J. et al. 2003. The specificities of protein kinase inhibitors: an update. Biochem J. 371, 199-204.2003) is used to show the validity of the current protein cluster derived using the current clustering method of the invention.

The clustering method of the instant invention classifies the kinases JNK (c-Jun N-terminal kinase), MKK (Mitogen activated protein kinase kinase), and SAPK3 (Stress-activated protein kinase 3) into a single cluster family in FIG. 6. These proteins are classified in different cluster families as per the old clustering tree FIG. 5, disclosed in Manning et al., 2002. The interaction pattern of the drug with the kinase reported in Bain et al., (2003) shows that the percentage of expression for the drug Purvalanol with kinases JNK, MKK, and SAPK3 are more than 80% as shown in Table 2. Hence, the method employed for clustering of proteins in the present invention is more reliable since it groups the proteins based on shared biochemical properties and similar function. Therefore, the biochemical properties of the proteins forming a cluster are well correlated, such as in the present case, the kinases grouping in same sub cluster display similar expression patterns. This process of clustering therefore can be reliably applied in the area of drug discovery.

TABLE 2

| | Old Cluster Family | | |
|---|---|---|---|
| | Manning el al., | New Cluster Family | % of Expression |
| Kinase | (2002) | (present invention) | Bain et al., (2003) |
| JNK | AGC | 2 | >80% |
| MKK | STE | 2 | >80% |
| SAPK2 | CMGC | 2 | >80% |

In another example based on kinases, the clustering method of the instant invention classifies the kinases LCK (Lymphocyte kinase) and GSKBeta (Glycogen synthase kinase β), into a single cluster family namely cluster 1 as shown in FIG. 6. The kinases MAPK2 and SAPK2 on the other hand are classified in cluster 2 as per the present invention. In sharp contrast to this, the old method (Manning et al., 2002) places all the four kinases namely LCK, GSK3Beta, MAPK2 (Mitogen-activated protein kinase 2), and SAPK2 in different cluster families (see FIG. 5). On correlating the interaction pattern of the drug with the kinases reported in Bain et al., (2003), it clearly emerged that the percentage of expression for the drug Indirubin-2-monoxime & Kenpaullone with the two kinases LCK and GSK3Beta belonging to cluster 1 as per the present invention, are similar and less than 40% (TABLE 3).

Similarly, the interaction pattern of both the kinases MAPK2 and SAPK2 was found to be more than 80% (Table 3). Hence, the method employed for clustering proteins in the present invention is more reliable since it groups the proteins based on shared biochemical properties and similar function. Therefore, the biochemical properties of the proteins forming a cluster are well correlated, such as in the present case, the kinases grouping in same sub-cluster display similar expression patterns. This process of clustering, therefore, can be reliably applied in the area of drug discovery.

In addition, the clustering method of the instant invention classifies the kinases MAPK2, and SAPK2, into a single cluster family FIG. 6. The interaction pattern of the drug with the kinase reported in Bain et al., (2003), Biochem. J., vol. 271: 199-204 shows that the percentage of expression for the drug Indirubin-2-monoxime & Kenpaullone with kinases LCK and GSKBeta, are more than 80% as shown in Table 2. This also indicates that these kinases are having similar interaction patterns.

TABLE 3

| | Old Cluster Family | | |
|---|---|---|---|
| | Manning et al., | New Cluster Family | % of Expression |
| Kinase | (2002) | (present invention) | Bain et al., (2002) |
| LCK | TK | 1 | <40% |
| GSKBeta | CMGC | 1 | <40% |
| MAPK2 | STE | 2 | >80% |
| SAPK2 | CMGC | 2 | >80% |

Additionally, the clustering method of the instant invention classifies the kinases CDK2 (Cyclin-dependent protein kinase 2), and AMPK (AMP-activated protein kinase) into a cluster 5 as shown in FIG. 6. These kinases are classified in different cluster families as per the old clustering tree as shown in FIG. 5, disclosed in Manning et al., 2002. The interaction pattern of the drug with the kinase reported in Bain et al., (2003) shows that the percentage of expression for the drug Alsterpaullone with kinases CDK2, and AMPK are less than 40% as shown in Table 4. This also indicates that these kinases have similar interaction patterns. Hence, the method employed for clustering of proteins in the present invention is more reliable since it groups the proteins based on shared biochemical properties and similar function. Therefore, the biochemical properties of the proteins forming a cluster are well correlated, such as in the present case, the kinases grouping in same sub cluster display similar expression patterns. This process of clustering therefore can be reliably applied in the area of drug discovery.

TABLE 4

| | Old Cluster Family | | |
|---|---|---|---|
| | Manning et al., | New Cluster Family | % of Expression |
| Kinase | (2002) | (present invention) | Bain et al., (2002) |
| CDK2 | CMGC | 5 | <40% |
| AMPK | AGC | 5 | <40% |

To provide further evidence for the reliability of the present invention, it was additionally tested if the kinases falling in different clusters also display dissimilar interaction pattern with drugs. The clustering method of the instant invention classifies the kinases CK2 (Casein kinase 2), and GSKBeta in different cluster families (5 and 1, respectively) as shown FIG. 6. However, kinases CK2, and GSKBeta are classified in the same cluster families as per the old clustering tree as shown FIG. 5 (Manning et al., 2002). The interaction pattern of the drug with the kinase reported in Bain et al., (2003) shows that the percentage of expression for the drug Kenpaullone with kinases CK2, and GSKBeta are different as shown in Table 5. Similarly, PKB (Protein kinase B), MKK (Mitogen activated protein kinase kinase), and MAPK2 are classified in the same cluster families as per the old clustering tree shown in FIG. 5, (Manning et al., 2002). In contrast, the clustering method of the instant invention classifies the kinases PKB, MKK, and MAPK2 in different cluster families as shown FIG. 6. The interaction pattern of the drug with the kinase reported in Bain et al., (2003) shows that the percentage of expression for the drug Kenpaullone with kinases PKB, MKK, and MAPK2 are also dissimilar as shown in Table 5. These observations indicate that the kinases with different interaction patterns are classified in separate clusters as per the method of present. Therefore, the method employed for clustering of proteins in the present invention is more reliable since it not only groups the proteins based on shared biochemical properties, but also places the proteins with dissimilar interaction patterns into separate clusters, as evident in the present case. This process of clustering therefore can be reliably applied in the area of drug discovery.

TABLE 5

| | Old Cluster Family | | |
|---|---|---|---|
| | Manning et al., | New Cluster Family | % of Expression |
| Kinase | (2002) | (present invention) | Bain et al., (2002) |
| CK2 | CMGC | 5 | >80% |
| GSKBeta | CMGC | 1 | <40% |
| PKB | STE | 4 | 40-60% |
| MKK | STE | 2 | >80% |
| MAPK2 | STE | 2 | 60-80% |

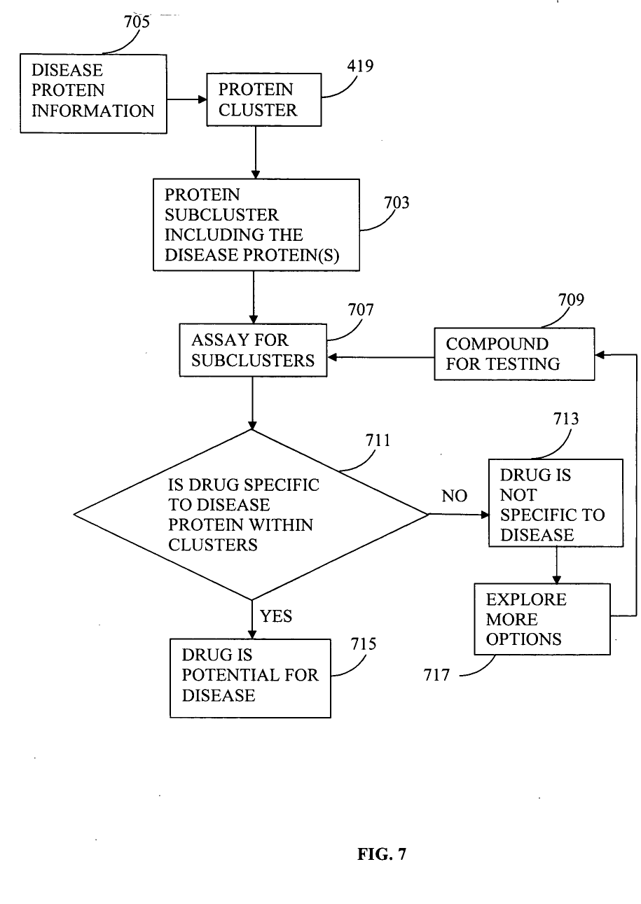

FIG. 7 provides a flow diagram showing the method of identifying a drug for the disease treatment. The protein clusters 419 based on the instant invention are used to identify potential drug for the treatment of a disease. The disease protein information 705 is derived using the metabolic pathway analysis, and protein interaction studies with different bio-molecules. The protein sub-clusters including the disease proteins 703 are subsequently derived. The assay for the disease protein of a sub cluster 707 is performed using different compounds 709. If the drug is specific to disease protein 711 within a cluster, the drug considered to be the potential drug 715 for the treatment of the disease. If it is not specific, different options are explored 717 in testing by different 709 compounds.

This process provides cost effective method of developing assays to study the interaction of a particular drug with the disease proteins. The process avoids developing assays for all the drugs by providing functionally related proteins to study the interaction pattern. This is the vital step in drug discovery for testing potential drug for a particular disease; hence the process of identifying a particular drug as the potential drug for a particular disease treatment of the current invention plays an important role in drug discovery.

In certain embodiments, pocket(s) or functional site(s) in proteins can be identified by reference to the scientific literature describing experimental results that indicate which amino acid residue(s) of the particular protein participate in, and preferably are critical for, the desired function. With information of this sort and a model (experimentally or computationally determined) of the structure of the protein (or a fragment thereof), a pocket(s) or functional site(s) according to the invention can be generated.

The invention relates to a method of identifying a compound capable of affecting a biochemical function of interest, the method comprising: (a) providing at least one protein belonging to a protein cluster with the biochemical function; (b) identifying a compound that binds to the protein; and (c) testing for the ability of the compound to affect the biochemical function in at least one member of the cluster.

In one embodiment, said method is automated. In one embodiment, the compound is known to bind to a member of the cluster. The effect of the compound on the biochemical function may consist of inhibition, activation, enhancement, modulation, binding, and allosteric effect.

The invention relates to a method of screening compounds capable of specifically interacting with a protein of interest having a biochemical function, the method comprising: (a) providing a protein cluster with a similar biochemical function as the protein of interest; (b) combining a member of the protein cluster and a candidate compound; and (c) determining the effect of the candidate compound on the biochemical function of the protein.

In one embodiment, the protein of interest correlated to a human disease or condition and the member of the protein cluster used to screen the candidate compound are different. In one embodiment, said method is automated. In one embodiment, the effect of the compound on the biochemical function is selected from the group consisting of inhibition, activation, enhancement, modulation, binding, and allosteric effect.

The invention provides a method of identifying a compound capable of specifically interacting with a protein of interest, the method comprising: (a) providing a protein cluster comprising the protein of interest identified according to the methods of the invention; (b) providing a three-dimensional structure of a functional domain of said protein cluster; and (c) using information comprising the three-dimensional structure of the functional domain to identify a compound that specifically interacts with the protein.

In one embodiment, the information for the three-dimensional structure of the functional domain further comprises amino acid residues related to a biochemical function selected from the group consisting of inhibition, activation, enhancement, modulation, binding, and allosteric effect on the protein of interest.

In one embodiment, the method is performed computationally. In another embodiment, the invention relates to a compound identified by the method.

In some embodiments of the methods of the invention, the biochemical function of said protein correlates to a human disease or condition. In one embodiment, the invention relates to a compound identified by the methods of this invention.

In another embodiment, the invention relates to methods of treating a human disease or condition by administering a therapeutically effective amount of the compound. In another embodiment, the invention relates to a compound identified by the methods of this invention for use in the preparation of a medicament for administration to a human or animal in need thereof. The need may relate to a disease or condition related to a biochemical function of a protein member of an identified cluster.

Another embodiment relates to a method of identifying a compound wherein the biochemical function is a catalytic function. Yet another embodiment of the present invention relates to a method of identifying a compound wherein the biochemical function is a modulatory function.

Another embodiment of the present invention relates to identifying a compound based on the protein functional domain which is selected from a group consisting of an active site, a ligand binding site, an allosteric site, a pocket, a functional site and a protein-protein interaction site.

Yet another embodiment of the present invention relates to an automated computer program product comprising a computer useable/readable medium having computer program code logic capable of clustering a set of proteins based on the pocket(s) sequences.

Yet another method of the present invention relates to a method of identifying a compound capable of distinctively interacting with a protein based on the protein clusters.

Yet another method of the present invention relates to a computer-readable storage medium having stored thereon a computer program comprising computer instructions for performing a method for the analysis, clustering and/or tree construction of a protein sequence according to any one of the methods of this invention when loaded on a computer.

The various techniques, methods, aspects, and embodiments of the invention can be implemented in part or in whole using computer-based systems and methods. Additionally, computer-based systems and methods can be used to augment or enhance the functionality described above, increase the speed at which the functions can be performed, and provide additional features and aspects as a part of or in addition to those of the present invention described elsewhere in this document. Representative computer-based systems, methods, and implementations in accordance with the above-described technology are now presented, although as will be appreciated, any suitable system may be employed to implement the instant invention.

Accordingly, this description is not intended to, and should not be construed as, implying a particular physical, logical, or structural architecture for implementing computer-based systems to carry out the invention. In fact, it will be apparent to one of ordinary skill in the art after reading this detailed description how to implement the various features and aspects of the invention using any suitable alternative processor architectures and configurations, including alternative combinations and configurations of computer software and hardware.

The various embodiments, aspects, and features of the invention may be implemented using hardware, software, or a combination thereof, and may be implemented using a computing system having one or more processors. The system can include one or more memories to allow computer programs or other instructions or data to be loaded into the computer system. Preferred memories include random access memory (RAM). One or more secondary memories can also be included. Secondary memory includes hard disk drives and removable storage devices such as floppy disk drives, magnetic tape drives, optical disk drives, etc. Typically, a removable storage drive reads from and/or writes to a removable storage medium. Removable storage media include floppy disks, magnetic tapes, optical disks, cartridges, removable memory chips, etc. that can be from read and written to. As will be appreciated, the removable storage media includes a computer usable storage medium having stored therein computer software and/or data.

A computer system can also include communications interfaces to allow software and data to be transferred between computer system and external devices. Examples of communications interfaces include modems, network interfaces (such as, for example, an Ethernet card), communications ports, PCMCIA slots and cards, etc. Software and data transferred via a communications interface typically are in the form of signals that can be electronic, electromagnetic, optical, or other signals capable of being received by the communications interface. Signals are typically provided to communications interfaces via one or more channels. Channels carry signals and can be implemented using a wireless medium, wire or cable, fiber optics, or other communications medium. Some examples of a channel can include a phone line, a cellular phone link, an RF link, a network interface, and other communications channels.

In this document, the terms “computer program medium” and “computer usable medium” are used to generally refer to media such as removable storage devices (e.g., a disk capable of installation in a disk drive) and signals on channel 528. These computer program products and the like allow software, program instructions, and data to be provided to the computer system.

Computer programs (also called computer control logic) typically are stored in a main memory and/or secondary memory. They may be provided by way of removable storage media or embedded in hardware (e.g., in an application specific integrated circuit (ASIC) or other hardware component. Computer programs can also be received via a communications interface. Computer programs, when executed, enable the computer system to perform the features of the present invention as discussed herein by manipulating and processing data in accordance with the encoded computer program logic. Accordingly, computer programs represent controllers of the computer system.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

The following examples are provided to authenticate the protein clusters of the instant invention, and in no way limit the scope of the invention.

### EXAMPLES

### Example 1

The method of converting a reference DNA sequence to a predicted peptide sequence using GENSCAN is provided herein. The gene sequence having gene identification (gi) number (NCBI) 1431097 when submitted to GENSCAN server annotates the sequence to its corresponding sequence as shown below:

| Gn. Ex | Type | S | .Begin | . . . End | .Len | Fr | Ph | I/Ac | Do/T | CodRg | P . . . | Tscr . . . |
|---|---|---|---|---|---|---|---|---|---|---|---|---|
| 1.03 | Ply A | — | 66 | 61 | 6 | | | | | | | 1.05 |
| 1.02 | Term | — | 1579 | 480 | 1100 | 2 | 2 | 3 | 40 | 789 | 0.832 | 56.85 |
| 1.01 | Init | — | 2277 | 1866 | 412 | 0 | 1 | 52 | 41 | 309 | 0.974 | 19.32 |

Predicted Peptide Sequence(s): Give Details of Protein Database or EMBL Number.

>503_aa
MTDVLRSLVRKISFNNSDNLQLKHKTSIQSNTALEKKKRKPDTIKKVSDVQVHHTVPNFN
NSSEYINDIENLLISKLIDGGKEGIAVDHIEHANISDSKTDGKVANKHENISSKLSKEKV
EKMINFDYRYIKTKERTSLVHKRVYKHDRKTDVDRKNHGGTIDISYPTTEVVGHGSFGVV
VTTVIIETNQKVAIKKVLQDRRYKNRELETMKMLCHPNTVGLQYYFYEKDEEDEVYLNLV
LDYMPQSLYQRLRHFVNLKMQMPRVEIKFYAYQLFK.ALNYLHNVPRICHRDIKPQNLLVD
PTTFSFKICDFGSAKCLKPDQPNVSYICSRYYRAPELMFGATNYSNQVDVWSSACVIAEL
LLGKPLFSGESGIDQLVEIIKIMGIPTKDEISGMNPNYEDHVFPNIKPITLAEIFKAEDP
DTLDLLTKTLKYHPCERLVPLQCLLSSYFDETKRCDTDTYVKAQNLRIFDFDVETELGHV
PLVERPAIEERLKHFVSAPSSSL

| | |
|---|---|
| Gn.Ex | gene number, exon number (for reference) |
| Type: | Init = Initial exon (ATG to 5′ splice site) |
| | Intr = Internal exon (3′ splice site to 5′ splice site) |
| | Term = Terminal exon (3′ splice site to stop codon) |
| | Sngl = Single-exon gene (ATG to stop) |
| | Prom = Promoter (TATA box/initation site) |
| | PlyA = poly-A signal (consensus: AATAAA) |
| S: | DNA strand (+ = input strand; − = opposite strand) |
| Begin: | beginning of exon or signal (numbered on input strand) |
| End: | end point of exon or signal (numbered on input strand) |
| Len: | length of exon or signal (bp) |
| Fr: | reading frame (a forward strand codon ending at x has frame x mod |
| | 3) |
| Ph: | net phase of exon (exon length modulo 3) |
| I/Ac: | initiation signal or 3′ splice site score (tenth bit units) |
| Do/T: | 5′ splice site or termination signal score (tenth bit units) |
| CodRg: | coding region score (tenth bit units) |
| P: | probability of exon (sum over all parses containing exon) |
| Tscr: | exon score (depends on length, I/Ac, Do/T and CodRg scores) |

### Example 2

The identification of pocket(s) or functional site(s) using the pocket information is described herein. It involves identification of pocket(s) or functional site(s) using the pocket information like residues in the active site from the database LIGPLOT of PDBSUM. The sequence of the protein having PDB id 1h8f in the PDBSUM exhibits two active site pockets (AC1, AC2) as shown in the FIG. 2.

### Example 3

The method of obtaining final structure conformation of the protein with respect to the sequence is explained herein. The final structural conformation is derived by either from the PDB or if it is new sequence it is being derived from a sequence alignment with that of the known structure which provides the summary of the protein with respect to its sequence. The information regarding its various feature are extracted from the PDB database including its sequence. In case of a new sequence the peptide chain is subjected to alignment using CLUSTALW and the conserved sequence identified. FIG. 2 is the pictorial representation of the structural conformation of a protein (PDB id 1H8F) which denotes the alpha helix (H1-H18), the beta sheets (A), loops (β), and residues in the active site pockets (AC1, AC2)

### Example 4

The characterization of the identified pocket(s) or functional site(s) for presence of substrate, cofactor, and other binding sites is explained herein. The exposed residues, exposed residue±(I) residue (where I=1, 2. . . ), and exposed residues+extended residues in pocket(s) or functional site(s) towards protein are taken for alignment along with sequence residue by CLUSTALW or CLUSTALX. In the structural information of 1H8F as shown in the FIG. 2 the first residue of the active site is the residue no 67 (F) followed by residue no 96 (R) and so on. In the characterization of the active pocket we take residue no 66 (S) and residue no 68 (G) followed by residue no 95 (N) and residues no 98 (E) and so on and derive a sequence of the particular/specific pocket. FIG. 4 provides a schematic representation of the methodology followed in analyzing pocket(s) or functional site(s) residues.

### Example 5

The functional classification of pocket(s) or functional site(s) from three dimensional to sequence level is explained herein. The method involves deducing the sequence information manually from the identified active sites identified from the predicted 3-D tertiary structure. The amino-acid pocket(s) or functional site(s) residues derived from functional sites of the protein are used as input sequences and subjected to a multiple sequence alignment using such software as CLUSTALW. It is a general purpose multiple sequence alignment program for DNA or proteins. It produces biologically meaningful multiple sequence alignments of divergent sequences. It calculates the best match for the selected sequences, and lines them up so that the identities, similarities and differences can be seen. The alignment file .aln is derived from the MSA. The mutations in the active site residues are identified through pair-wise comparison and evolutionary relationship are thus drawn which is the basis of the clustering. The output file is available as dnd file. The clustering of the proteins can be visualized as phylogram or cladograms using software such as PHYLODRAW or TREEVIEW which support the dnd format of the output file from CLUSTALW. PHYLODRAW is a drawing tool for creating phylogenetic trees. PHYLODRAW supports various kinds of multiple sequence alignment programs (Dialign2, CLUSTALW, Phylip format, and pair wise distance matrix) and visualizes various kinds of tree diagrams, such as rectangular cladogram, slanted cladogram, phylogram, free tree, and radial tree. With PHYLODRAW users can manipulate the shape of a phylogenetic tree easily and interactively by using several control parameters. This program can export the final tree layout to BMP (bitmap image format) and Postscript.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

We claim:

1. A method of clustering proteins based on sequences of at least one functional domain, the method comprising the steps of:
(a) providing a plurality of similar or related protein sequences based on comparison with a polypeptide sequence;
(b) obtaining a three-dimensional structure of said proteins;
(c) identifying a functional domain of said proteins from said three-dimensional structure; and
(d) clustering said protein sequences based on a sequence similarity of the functional domain.

2. The method of claim 1, wherein the plurality of similar or related protein sequences is obtained by:
providing a query polypeptide sequence;
searching at least one database wherein the query sequence is compared to at least one sequence in the database; and
retrieving the plurality of similar or related protein sequences based on comparison with the query sequence.

3. The method of claim 1, further comprising the steps of:
(e) generating a dendrogram comprising protein clusters having similar functional sites.

4. The method of claim 3, wherein the protein clusters having similar functional sites have similar biochemical functions.

5. The method of claim 2, wherein the query polypeptide sequence is generated by converting a reference DNA sequence to a predicted polypeptide sequence.

6. The method of claim 1, wherein identifying the functional site(s) of said proteins from said three-dimensional structure comprises deducing a sequence of the functional site.

7. The method of claim 2, wherein the conversion of the reference DNA sequence to the predicted peptide sequence is carried out by a program selected from a group consisting of GENSCAN, GRAIL, HMMgene, MZEF, Genfinder, Genemark, GeneEXP, and GenLang.

8. The method of claim 2, further comprising searching a database selected from the group consisting of NCBI, Expasy, PFAM, and PROSITE.

9. The method of claim 2, further comprising comparing the query sequence to the database using algorithms selected from the group consisting of BLAST, WU-BLAST2 and FASTA.

10. The method of claim 1, wherein in step (b), the three-dimensional protein structure is a protein model selected from the group consisting of a high resolution model, a moderate resolution model, and a low resolution model.

11. The method of claim 1, wherein the said three-dimensional structure is experimentally determined.

12. The method of claim 1, wherein the said three-dimensional structure is computationally determined.

13. The method of claim 1, wherein computationally determining the said three dimensional structures is carried out using a tool selected from a group consisting of Modeller, Prime, Swissmodel, CPH model or equivalents thereof.

14. The method of claim 1, wherein in step (c), identifying the functional site(s) of said proteins from said three-dimensional structure involves using a PDBSUM database or manual analysis.

15. The method of claim 1, wherein in step (d), the clustering is based on the sequence similarity of the functional site(s), by using a tool selected from the group consisting of CLUSTALW and CLUSTALX, or equivalents thereof.

16. The method of claim 3, wherein in step (e), generating the dendrogram for said set of proteins is carried out by using tool selected from a group consisting of PHYLODRAW, NJPLOT, GENETREE, PHYLIP, GENEDOC, DAMBE, TREECON, TREEVIEW and SPECTRUM, or equivalents thereof.

17. The method of claim 1, wherein said protein functional domain is selected from the group consisting of an active site, a ligand binding site, an allosteric site, a pocket, a functional site and a protein-protein interaction site.

18. The method of claim 3, wherein the dendrogram comprises one or more of said protein clusters obtained by the method of claim 1.

19. The method of claim 1, wherein the protein clusters comprise proteins with similar biochemical functions.

20. A dendrogram obtained by a method according to claim 3.

21. A protein cluster obtained by a method according to claim 1.

22. An automated computer program product comprising a computer useable/readable medium having computer program code logic capable of clustering a set of proteins based on functional domain sequences according to claim 1.

23. A computer-readable storage medium having stored thereon a computer program comprising computer instructions for performing a method for the analysis, clustering and/or tree construction of a protein sequence according to claim 1 when loaded on a computer.

24. A method of identifying a compound capable of affecting a biochemical function of interest, the method comprising:
(a) providing at least one protein belonging to a protein cluster with the biochemical function according to the method of claim 1;
(b) identifying a compound that binds to the protein; and
(c) testing for the ability of the compound to affect the biochemical function in at least one member of the cluster.

25. The method of claim 24, said biochemical function of said protein correlates to a human disease or condition.

26. The method of claim 24, wherein the compound is previously known to bind to a member of the cluster.

27. The method of claim 24, wherein the effect of the compound on the biochemical function is selected from the group consisting of inhibition, activation, enhancement, modulation, binding, and allosteric effect.

28. A compound identified by the method of claim 24 that specifically interacts with a target protein.

29. A method of treating a human disease or condition by administering a therapeutically effective amount of the compound identified by the method of claim 24.

30. A method of screening compounds capable of specifically interacting with a protein of interest having a biochemical function, the method comprising:
(a) providing a protein cluster with a similar biochemical function as the protein of interest, according to the method of claim 1;
(b) combining a member of the protein cluster and a candidate compound; and
(c) determining the effect of the candidate compound on the biochemical function of the protein.

31. The method of claim 30, said biochemical function of the protein of interest correlates to a human disease or condition.

32. The method of claim 31, wherein the protein of interest correlated to a human disease or condition and the member of the protein cluster used to screen the candidate compound are different.

33. A compound identified by the method of claim 30 that specifically interacts with a target protein.

34. A method of treating a human disease or condition by administering a therapeutically effective amount of the compound identified by the method of claim 30.

35. A method of identifying a compound according to claim 30, wherein the effect of the compound on the biochemical function is selected from the group consisting of inhibition, activation, enhancement, modulation, binding, and allosteric effect.

36. A method of identifying a compound capable of specifically interacting with a protein of interest, the method comprising:
(a) providing a protein cluster comprising the protein of interest identified according to the method of claim 1
(b) providing a three-dimensional structure of a functional domain of said protein cluster; and
(c) using information comprising the three-dimensional structure of the functional domain to identify a compound that specifically interacts with the protein.

37. The method of claim 36, wherein the information for the three-dimensional structure of the functional domain further comprises amino acid residues related to a biochemical function selected from the group consisting of inhibition, activation, enhancement, modulation, binding, and allosteric effect on the protein of interest.

38. The method of claim 36, wherein said method is performed computationally.

39. A compound identified by the method of claim 36 that specifically interacts with the protein of interest.

40. The method of claim 37, wherein the biochemical function is related to a human disease or condition.

41. A drug for use in the treatment or therapy of a human disease or condition comprising:
a compound identified by a method of claim 40; and
a pharmaceutically acceptable excipient.
